(19) United States
(12) Patent Application Publication
(10) Pub. No.: US 2013/0115400 A1
(43) Pub. Date: May 9, 2013

(54) HOLLOW TOY STRUCTURE

(71) Applicant: MING-YI CHOU, Taoyuan County (TW)

(72) Inventor: MING-YI CHOU, Taoyuan County (TW)

(73) Assignee: Jumball Industries Corp., Taoyuan County (TW)

(21) Appl. No.: 13/291,356

(22) Filed: Nov. 8, 2011

(51) Int. Cl. B32B 1/00; B32B 25/00; B32B 27/00

(52) U.S. Cl. 428/36.8; 428/34.1; 428/35.7

(57) ABSTRACT

A hollow toy structure includes at least a first and a second shell portion, which are configured as two three-dimensional concave members with their rims forming two mating joining surfaces, which can be assembled to each other for closing the first shell portion to the second shell portion to form a hollow body. On and along the joining surface of the first shell portion, there is provided at least one annular groove as a first coupling structure, which is located between an outer and an inner surface of the first shell portion; and on and along the joining surface of the second shell portion, there is provided at least one retaining ring as a second coupling structure for complementarily engaging with the annular groove. And, a bonding layer is applied on between the joining surfaces of the first and second shell portions to bond the two shell portions together.

### FIELD OF THE INVENTION

The present invention relates to a hollow toy structure, and more particularly to a hollow toy structure that can be easily manufactured and allows convenient addition of other design changes to the finished product thereof.

### BACKGROUND OF THE INVENTION

Many toys are manufactured as a hollow body in order to reduce the weight or to increase the elasticity of the toy. Compared to a solid body, the hollow body requires less material and is much lighter in weight. Moreover, the hollow body is more easily transformable under compression by an external force applied thereto and can therefore provide buffer against impact thereon. That is why many elastic toys are manufactured as hollow toys, i.e. have a hollow structure.

Conventionally, a hollow body can be manufactured by way of centrifugal casting, blow molding, injection molding and the like. However, all the above conventional ways for forming a hollow body have some disadvantages. Taking the manufacture of a hollow ball as an example, both of the centrifugal casting and the blow molding allow the production of an integrally formed hollow ball with an almost perfectly smooth outer surface. However, the hollow ball so produced could not be internally provided with other additional structures or devices.

FIG. 1 illustrates the steps included in a conventional way for forming a hollow ball through injection molding. Since the injection molding requires an injection gate 40 on the mold, an ugly gate mark 41 would be left on the surface of the produced ball. Further, for the ball to have a hollow structure, it is necessary to use an additional pit-like internal mold 42 in the original injection mold, and the internal mold 42 must be drawn out of the hollow ball when the latter is still in a half-set state. These procedures inevitably increase the complexity and cost of the injection mold, and necessitate higher injection pressure of the injection molding machine. To successfully draw the pit-like internal mold 42 out of the hollow ball, highly accurate timing for such drawing is required and care must be taken to avoid damaging the ball. In addition, just like the centrifugal casting, the injection molding does not allow the produced hollow body to be internally provided with other functional devices or externally provided with design changes, preventing the hollow toy so produced from having a somewhat more complicated structure.

It is therefore tried by the inventor to develop an improved hollow toy structure to eliminate the drawbacks in the conventional hollow toys.

### SUMMARY OF THE INVENTION

A primary object of the present invention is to provide a hollow toy structure that can be easily manufactured and allows convenient addition of other design changes to the finished product thereof.

To achieve the above and other objects, the hollow toy structure according to the present invention includes at least a first and a second shell portion, which are configured as two three-dimensional concave members with their rims forming two mating joining surfaces, which can be assembled to each other for closing the first shell portion to the second shell portion to form a hollow body. On and along the joining surface of the first shell portion, there is provided at least a first coupling structure; and on and along the joining surface of the second shell portion, there is provided at least a second coupling structure for complementarily engaging with the first coupling structure. And, a bonding layer is applied on between the joining surfaces of the first and second shell portions to bond the two shell portions together.

In a preferred embodiment, the first shell portion and the second shell portion are two hemispherical shell members. And, the joining surfaces of the first and second shell portions respectively have a normal vector tangential to an outer surface of the shell portions.

In another preferred embodiment, the first coupling structure is an annular groove located between an outer surface and an inner surface of the first shell portion, such that the annular groove has an outer sidewall portion and an inner sidewall portion raised therefrom; and the second coupling structure is a retaining ring configured complementarily corresponding to the annular groove, such that the retaining ring has an outer shoulder portion and an inner shoulder portion retreating therefrom.

In a further preferred embodiment, the outer sidewall portion is higher than the inner sidewall portion; and the outer shoulder portion is lower than the inner shoulder portion.

In a still further preferred embodiment, the bonding layer is selected from the group consisting of a layer of a bonding adhesive, a welded layer formed through high-frequency welding, a welded layer formed through ultrasonic welding, and a layer of hot-melt adhesive.

According to a preferred embodiment of the present invention, the first and the second shell portion are made of a thermoplastic elastomer material selected from the group consisting of a thermoplastic polyurethane material, a thermoplastic olefin elastomer, a thermoplastic vulcanizate elastomer, a thermoplastic polystyrene elastomer, a thermoplastic polyester elastomer, and a thermoplastic polyamide elastomer.

According to another embodiment, the first and the second shell portion may be respectively provided on a surface with at least one shaped opening.

According to a further embodiment, the hollow body is internally provided with a device, such as a bell, a luminous body or a pet diet feeder.

The present invention is characterized by a hollow toy structure that can be assembled from at least a first shell portion and a second shell portion. The first and the second shell portion are configured as two three-dimensional concave members with their rims being formed into two mating joining surfaces, so that the first and second shell portions can be easily put together to form a hollow body. On and along the joining surface of the first shell portion, there is provided at least one first coupling structure, and on and along the joining surface of the second shell portion, there is provided at least one second coupling structure for complementarily engaging with the first coupling structure. A bonding layer may be evenly applied on between the joining surfaces of the first and the second shell portion. These arrangements simplify the manufacture process and upgrade the production efficiency and good yield of the hollow toy. Therefore, the hollow toy structure according to the present invention can be easily manufactured and allows convenient addition of other design changes to the finished product thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 illustrates a conventional process of manufacturing a hollow toy;

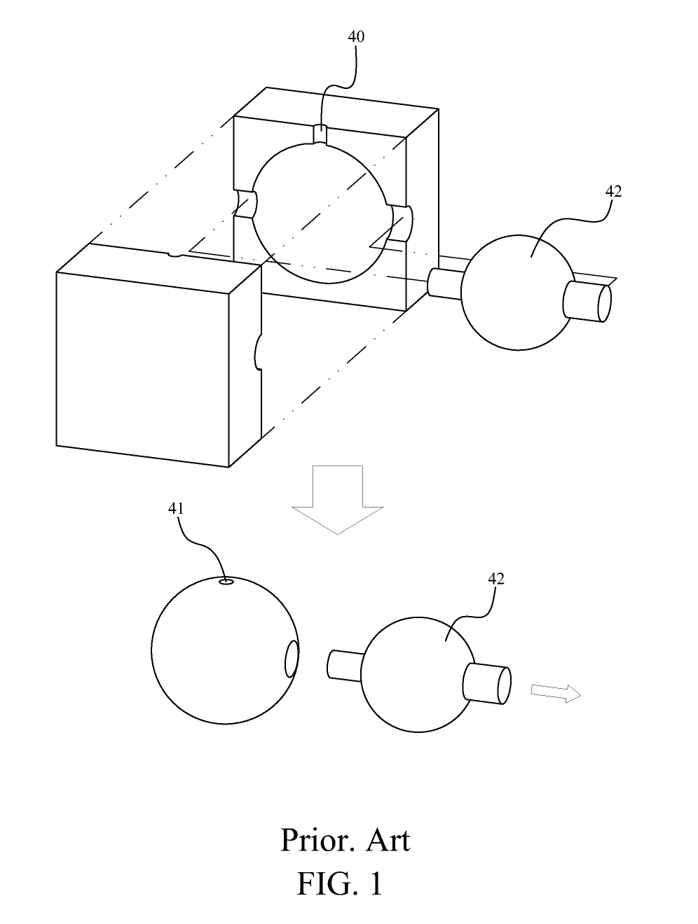

FIG. 2 is an exploded perspective view of a hollow toy structure according to a first preferred embodiment of the present invention, showing the manner of assembling same;

FIG. 3 is an assembled sectional view of FIG. 2;

FIG. 4 is an enlarged view of the circled area A of FIG. 3;

FIG. 5 shows the hollow toy structure of the present invention is deformed under compression by an external force applied thereto; and

FIG. 6 is a phantom view of a hollow toy structure according to a second preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

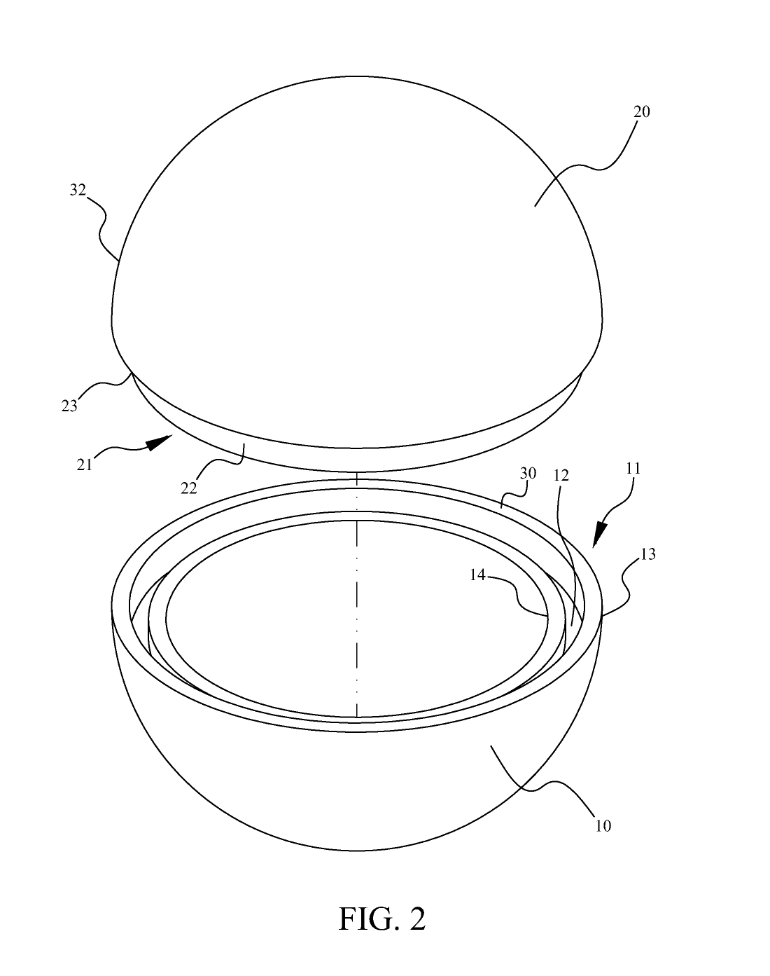

Please refer to FIGS. 2, 3 and 4. A hollow toy structure according to a first preferred embodiment of the present invention includes a first shell portion 10 and a second shell portion 20. The first shell portion 10 and the second shell portion 20 may be configured as three-dimensional concave members and made of a thermoplastic elastomer material, such as, for example, a thermoplastic polyurethane material, a thermoplastic olefin elastomer, a thermoplastic vulcanizate elastomer, a thermoplastic polystyrene elastomer, a thermoplastic polyester elastomer, or a thermoplastic polyamide elastomer. The rims of the first and the second shell portion 10, 20 are provided and configured as two mating joining surfaces 30, which can be suitably assembled to each other for closing the first shell portion 10 to the second shell portion 20 and forming a hollow body 36. In the illustrated first preferred embodiment, the first shell portion 10 and the second shell portion 20 are respectively a hemispherical shell, such that the closed first and second shell portions 10, 20 together form a complete spherical shape.

It is understood the first and the second shell portion 10, 20 are not necessarily two symmetrical hemispherical shells, which are illustrated only as an example to facilitate easy explanation of the present invention and not intended to limit the present invention in any way. That is, the first and the second shell portion 10, 20 may be otherwise two cubic shells, two polygonal shells, or two irregularly curved shells, depending on actual need. Further, in addition to the above described two symmetrical hemispherical shells, the first and the second shell portion 10, 20 may be otherwise configured to have their joining surfaces 30 being two eccentric planar surfaces, two irregularly bent or curved surfaces, or two zigzag or toothed surfaces, depending on actual-use conditions. Alternatively, three or more pieces of shell portions may be provided for putting into a complete shell for the hollow toy.

On and along the joining surface 30 of the first shell portion 10, there is provided at least one first coupling structure 11, and on and along the joining surface 30 of the second shell portion 20, there is provided at least one second coupling structure 21 corresponding to the first coupling structure 11, such that the first and the second coupling structure 11, 21 are automatically fastened together when the first and the second shell portion 10, 20 are closed to each other. And, to ensure a tight connection of the first shell portion 10 to the second shell portion 20, a bonding layer 31 may be further applied on between the joining surfaces 30 of the first and second shell portions 10, 20. The bonding layer 31 is adhered to the first and the second shell portion 10, 20 to thereby increase the bonding strength between the two shell portions 10, 20.

In the illustrated first preferred embodiment, the bonding layer 31 is a thin film of a bonding adhesive without being limited thereto. That is, the bonding layer 31 may be otherwise a welded layer formed through high-frequency welding, a welded layer formed through ultrasonic welding, or a layer of a hot-melt adhesive, depending on actual need in use.

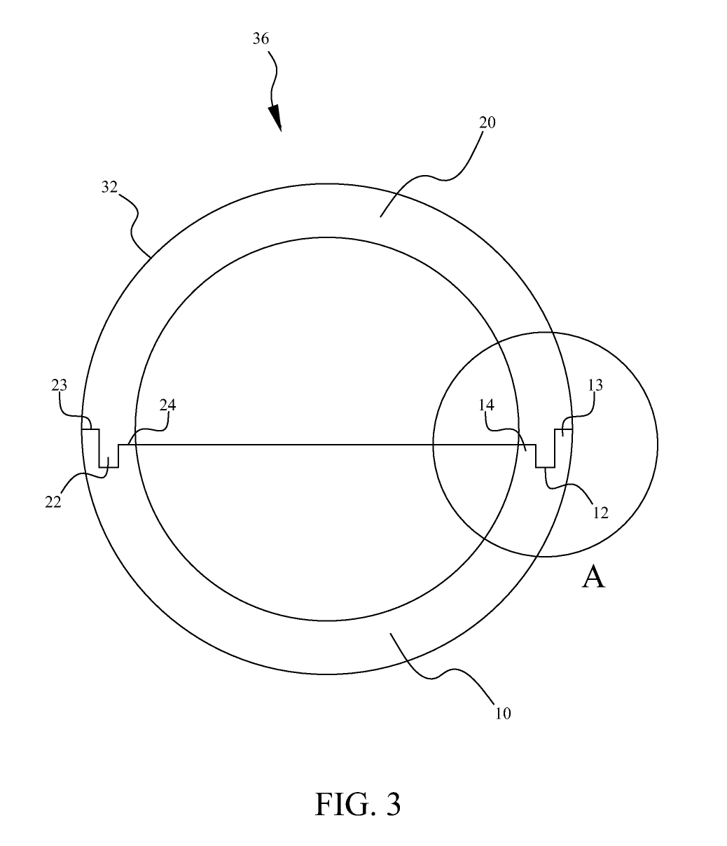

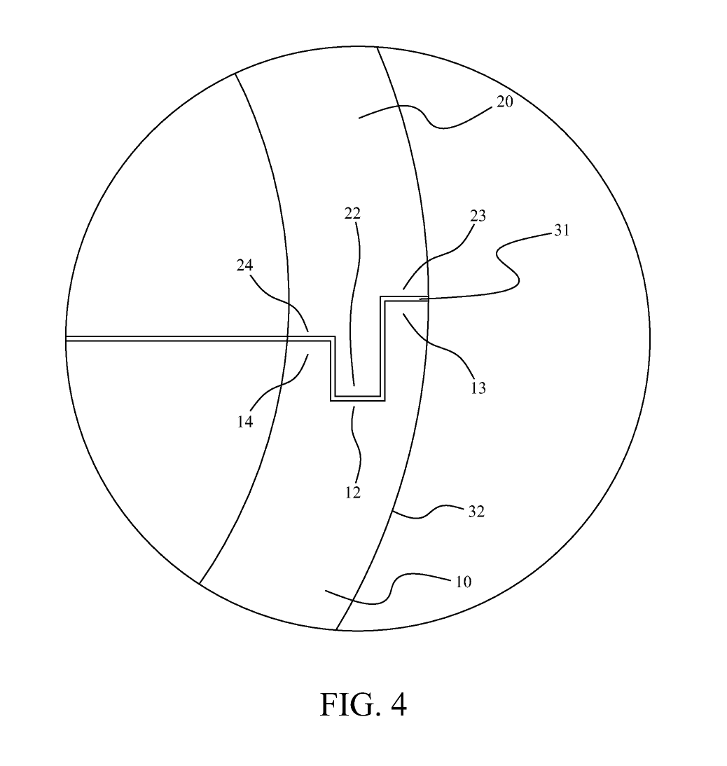

Please refer to FIGS. 3 and 4 at the same time. As shown, the joining surfaces 30 of the first and the second shell portion 10, 20 all have a normal vector tangential to an outer surface 32 of the hollow body 36. And, the first coupling structure 11 and the second coupling structure 21 are an annular groove 12 and a retaining ring 22, respectively, perpendicular to the joining surfaces 30. The annular groove 12 and the retaining ring 22 are complementarily engaged with each other to allow a self-locking connection between the first and the second shell portion 10, 20.

Furthermore, in the illustrated first preferred embodiment, the annular groove 12 formed on the joining surface 30 of the first shell portion 10 is located between an outer and an inner surface of the first shell portion 10, such that the annular groove 12 has a radially outer sidewall portion 13 and a radially inner sidewall portion 14 raised from the annular groove 12. On the other hand, the retaining ring 22 formed on the joining surface 30 of the second shell portion 20 is configured complementarily corresponding to the annular groove 12 to have a radially outer shoulder portion 23 and a radially inner shoulder portion 24 retreating from the retaining ring 22. In the case of using the bonding layer 31, the adhesive for forming the bonding layer 31 may be received in the entire annular groove 12. The bonding layer 31 and the complementarily mating structure of the annular ring 12 and the retaining ring 22 together further effectively increase the bonding strength between the assembled first and second shell portions 10, 20. It is noted, in the illustrated first preferred embodiment, to enable easier engagement of the retaining ring 22 with the annular groove 12, the outer sidewall portion 13 is further configured to be higher than the inner sidewall portion 14 while the outer shoulder portion 23 is lower than the inner shoulder portion 24.

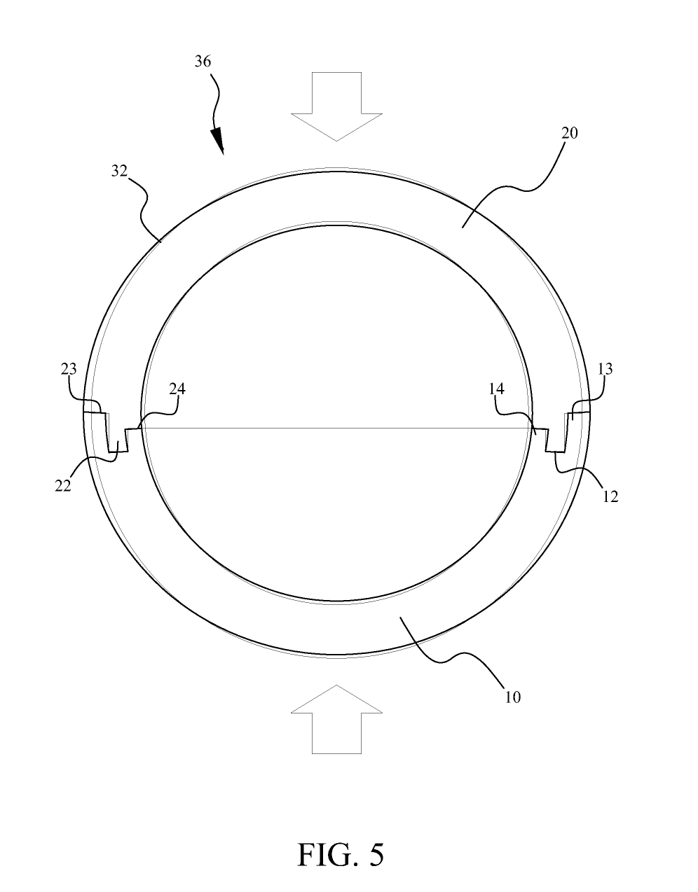

Please refer to FIG. 5. When the hollow toy structure of the present invention is subjected to an external force sidewardly applied along the joining surfaces 30 of the first and the second shell portion 10, 20, the spherical hollow body 36 made of an elastic material tends to deform under the applied external force. As shown in FIG. 5, a distance between two diametrically opposite ends of the spherical hollow body 36 parallel to the direction of the applied force is shortened while a distance between another two diametrically opposite ends perpendicularly to the applied force direction is extended. Generally, there would be a certain degree of error between the extents of elastic deformation of the first and the second shell portion 10, 20, which tends to pull the first and the second shell portion 10, 20 apart from each other at the joining surfaces 30. However, in the present invention, the annular groove 12 and the retaining ring 22 are so configured that the joining surfaces 30 and the bonding layer 31 between the first and the second shell portion 10, 20 have increased areas, over which an overall tearing tension generated by the elastic deformation can evenly distribute to thereby reduce the tearing tension in each unit area.

Since the outer shoulder portion 13 and the inner shoulder portion 14 of the retaining ring 22 respectively have a thickness much smaller than a total thickness of the first and the second shell portion 10, 20, they are more easily deformed under the compression caused by an external force applied thereto. This property in turn allows a reduced deformation error between the retaining ring 22 and the annular groove 12, and accordingly, reduces the tearing tension generated by the elastic deformation error between the first and the second shell portion 10, 20.

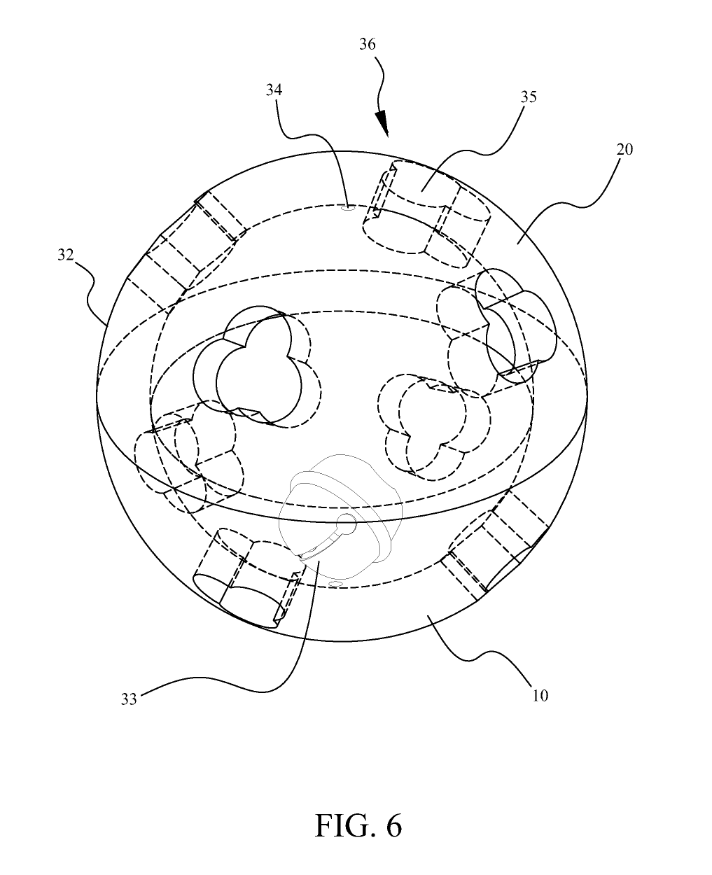

FIG. 6 shows a hollow toy structure according to a second preferred embodiment of the present invention. Since the hollow toy structure according to the present invention includes at least two shell portions that can be put together to form a hollow body 36, a manufacturer may very conveniently provide additional devices 33 in a space defined in the hollow body 36. For example, as shown in FIG. 6, a small bell is put in the hollow body 36 as an additional device 33. Alternatively, according to the actual need in use, the additional device 33 can be, for example, a luminous body or a pet diet feeder or the like. According to the present invention, the first shell portion 10 and the second shell portion 20 are separately molded, allowing the manufacturer to easily arrange a gate mark 34 on an inner side of the spherical hollow body 36 and therefore giving the completed spherical hollow body a more beautiful appearance. Further, differently shaped openings 35 as shown in FIG. 6 may be provided on the surface of the spherical hollow body 36, or the shell portions 10, 20 may be molded through two-component injection molding to obtain other changes in the produced hollow toy. Since the molds for forming the hollow toy are simplified, the manufacturing cost and the requirements for the injection molding machine can be largely reduced.

In brief, the present invention provides a hollow toy structure that can be assembled from at least a first shell portion and a second shell portion. The first and the second shell portion are configured as two three-dimensional concave members with their rims being formed into two mating joining surfaces, so that the first and second shell portions can be easily put together to form a hollow body. On and along the joining surface of the first shell portion, there is provided at least one first coupling structure, and on and along the joining surface of the second shell portion, there is provided at least one second coupling structure for complementarily engaging with the first coupling structure. A bonding layer may be evenly applied on between the joining surfaces of the first and the second shell portion to simplify the manufacture process and upgrade the production efficiency and good yield of the hollow toy. Therefore, the hollow toy structure according to the present invention can be easily manufactured and allows convenient addition of other design changes to the finished product thereof.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A hollow toy structure, comprising at least a first shell portion and a second shell portion; the first and the second shell portion being two three-dimensional concave members, rims of the first and second shell portions being provided and configured as two mating joining surfaces, which can be assembled to each other for closing the first shell portion to the second shell portion to form a hollow body; on and along the joining surface of the first shell portion, there being provided at least one first coupling structure; on and along the joining surface of the second shell portion, there being provided at least one second coupling structure for complementarily engaging with the first coupling structure; and a bonding layer being applied on between the joining surfaces of the first and second shell portions.

2. The hollow toy structure as claimed in claim 1, wherein the first shell portion and the second shell portion are two hemispherical shell members.

3. The hollow toy structure as claimed in claim 1, wherein the joining surfaces of the first and second shell portions respectively have a normal vector tangential to an outer surface of the hollow body.

4. The hollow toy structure as claimed in claim 1, wherein the first coupling structure is an annular groove located between an outer surface and an inner surface of the first shell portion, such that the annular groove has an outer sidewall portion and an inner sidewall portion raised therefrom; and wherein the second coupling structure is a retaining ring configured complementarily corresponding to the annular groove, such that the retaining ring has an outer shoulder portion and an inner shoulder portion retreating therefrom.

5. The hollow toy structure as claimed in claim 4, wherein the outer sidewall portion is higher than the inner sidewall portion; and the outer shoulder portion is lower than the inner shoulder portion.

6. The hollow toy structure as claimed in claim 1, wherein the bonding layer is selected from the group consisting of a layer of a bonding adhesive, a welded layer formed through high-frequency welding, a welded layer formed through ultrasonic welding, and a layer of hot-melt adhesive.

7. The hollow toy structure as claimed in claim 1, wherein the first and the second shell portion are made of a thermoplastic elastomer material selected from the group consisting of a thermoplastic polyurethane material, a thermoplastic olefin elastomer, a thermoplastic vulcanizate elastomer, a thermoplastic polystyrene elastomer, a thermoplastic polyester elastomer, and a thermoplastic polyamide elastomer.

8. The hollow toy structure as claimed in claim 1, wherein the first shell portion is provided on a surface with at least one shaped opening.

9. The hollow toy structure as claimed in claim 1, wherein the second shell portion is provided on a surface with at least one shaped opening.

10. The hollow toy structure as claimed in claim 1, wherein the hollow body is internally provided with a device selected from the group consisting of a bell, a luminous body, and a pet diet feeder.
